(19) United States
(12) Patent Application Publication
(10) Pub. No.: US 2014/0377013 A1
(43) Pub. Date: Dec. 25, 2014

(54) USE OF POLYAMINE AS ANTI-STICKING ADDITIVE

(71) Applicants: Alexander Puzrin, Zurich (CH); Michael Plötze, Zürich (CH); Lorenz Meier, Zurich (CH); Rolf Zumsteg, Zurich (CH)

(72) Inventors: Alexander Puzrin, Zurich (CH); Michael Plötze, Zürich (CH); Lorenz Meier, Zurich (CH); Rolf Zumsteg, Zurich (CH)

(73) Assignee: CONSTRUCTION RESEARCH & TECHNOLOGY GMBH, Trostberg (DE)

(21) Appl. No.: 14/238,335

(22) PCT Filed: Aug. 17, 2012
(86) PCT No.: PCT/EP2012/066117

§ 371 Date: Jul. 30, 2014

(30) Foreign Application Priority Data
Aug. 22, 2011 (EP) 11178222.3

(51) Int. Cl. E02D 3/00; C09K 8/035

(52) U.S. Cl. CPC E02D 3/00; C09K 8/035
USPC 405/264

(57) ABSTRACT

Method of use of at least one polyamine compound selected from the group consisting of diethylenetriamine: triethylenetetramine (TETA), tetraethylengentemine (TEPA). pentaethylenehexamine (PEHA), hexaethyieneheptamine and heptaethyleneoctamine sticking decreasing additive for soil with a day mineral content o more than 10% by weight.

Subject of this invention is a method of use of at least one polyamine as sticking decreasing additive for clay containing soils.

It is prior art knowledge that polymeric additives in modest concentrations of less than 0.5% by mass are widely used in tunneling applications to treat the soils and thereby improving the mechanical properties of the excavated ground. The main function of the polymeric additives can be seen in controlling the water content of the excavated soil, acting as dispersing agent and preventing the clay containing soils from clumping. Since the mechanism of polymer adsorption and their resulting alteration of the soil mechanical properties of paste-like mixtures for the use in the earth pressure shield in tunnel boring machines is still not well understood there have been a lot of suggestions and proposals for new chemical developments regarding the additives and their polymeric characteristics.

There are existing test results regarding the use of the commercial polymer products “Rheosoil 211” and “Rheosoil 214” in smectite, kaolinite and illite containing soils. Although a lubrication effect can be shown, the polymers cannot drastically decrease stickiness in soils with a high content of illite and smectite.

Because of this lack of efficiency it was an object of this invention to find alternative anti-sticking additives for specific clay containing soils.

In the publication of Moore and Mitchell (1974, Geotechnique, 24, 627-640) the effect of the dielectric properties of the pore fluid on shear strength of clay has been studied and analytical techniques for expressing electromagnetic forces of interaction in soils regarding kaolinite were described. It was concluded by the authors that pore fluids with a dielectric constant in the range of clay dielectric constant can decrease the shear strength considerably and have a strong effect on the mechanical behavior.

It is an object of the present invention to provide a method of use of at least one polyamine compound selected from the group consisting of diethylenetriamine, triethylenetetramine (TETA), tetraethylenpentamine (TEPA), pentaethylenehexamine (PEHA), hexaethyleneheptamine and heptaethyleneoctamine as sticking decreasing additive for soil with a clay mineral content of more than 10% by weight.

By using the selected polyamines or mixtures thereof as anti-sticking additive it can be shown that aqueous systems containing clay change their mechanical properties and above all show drastically decreased sticking potential.

Although a big influence of polyamines on the mechanical properties of clay mixtures could be expected (Moore and Mitchell; 1974), the strong anti-sticking effect is unexpected and happens to be much higher than with commercial polymer products. This clear anti-sticking effect of clay-water-polyamine mixtures can be observed over a broad range of water contents of the mixture and for metal, porcelain and other surfaces. Surprisingly other etheramines such as triethylamine and polyethylenimine with a high molecular mass up to 500 000 g/mol and also triethanolamine show much less influence on the sticking behavior of clay and especially illite containing systems.

Increased size of polyamines (number of amine and ethylene groups) reflect in decreased sticking behavior of the clay-water-polyamine mixtures.

The method according to the present invention shows its surprising effects preferably in soil systems containing at least one clay mineral representative selected from illite, kaolinite and smectite.

It is also possible to use the polyamine or mixtures thereof in combination with polycarboxylates based dispersants whereby the dispersants can also show anti-sticking properties towards a clay.

TEPA, the other polyamines and all the dispersants can according to the present invention be used in liquid form and/or preferably as one combined liquid additive.

Because of its surprising features in decreasing the stickiness the polyamine is used according to the present invention preferably during tunnel excavation.

Surprisingly it could be shown by the new method that TEPA is mainly advantageous in soils containing illite as main clay mineral, and PEHA in soils mainly containing kaolinite and/or smectite.

In a preferred embodiment of the present invention the method is characterized in that the polyamine is used at a concentration of from 0.5 to 2.0% by weight, and preferably of 1.0% by weight of the clay mineral content.

In a preferred embodiment of the present invention the method is characterized in that the clay is represented by at least one species selected from the group consisting of illite, kaolinite and smectite.

In a preferred embodiment of the present invention the method is characterized in that the polyamine is used in combination with polycarboxlates based dispersants.

In a further preferred embodiment of the present invention the method is characterized in that the dispersants have anti-sticking properties over clay.

A further preferred embodiment of the invention the method is characterized in that the polyamine and/or the dispersant is/are used in liquid form, and preferably as one combined liquid additive.

A further preferred embodiment of the invention the liquid is characterized in that the liquid additive is applied to the clay containing soil in amounts of from 0.5 to 2.0% by weight and preferring of 1.0% by weight of the clay mineral content.

In a further embodiment of the invention the method is characterized in that the TEPA is used in the case that the clay is represented mainly by illite.

In a further embodiment of the invention the method is characterized in that PEHA is used in the case that the clay is represented mainly by kaolinite and/or smectite.

In a further embodiment of the invention the method is characterized in that the polyamine is used during tunnel excavation.

The example show the surprising advantages of selected polyamines as sticking decreasing additive for illite mixtures:

### EXAMPLE 1

In total four mixtures were prepared, weighing in 1500 g of dry illite powder and the desired amount of water (which is suitable for the TBM operation) and chemical in the mixing bowl of a Hobart kitchen mixer
1020 g (68%) water, without chemical;
1005 g (67%) water, 15 g TETA (1 % of dry illite weight);
1005 g (67%) water, 15 g TEPA (1 % of dry illite weight);
1005 g (67%) water, 15 g PEHA (1 % of dry illite weight);

After installation of the mixing bowl and the mixing tool in the mixer, the mixing process for the desired mixture was started. After a fixed mixing time (3 min) the weight of soil sticking to the mixing paddle was determined and, divided by the total initial weight of wet soil in the mixer.

Next, the mixing bowl with the remaining soil was turned upside down. The weight of soil sticking to the bowl after overturning was determined and divided by the weight of soil in the bowl before overturning.

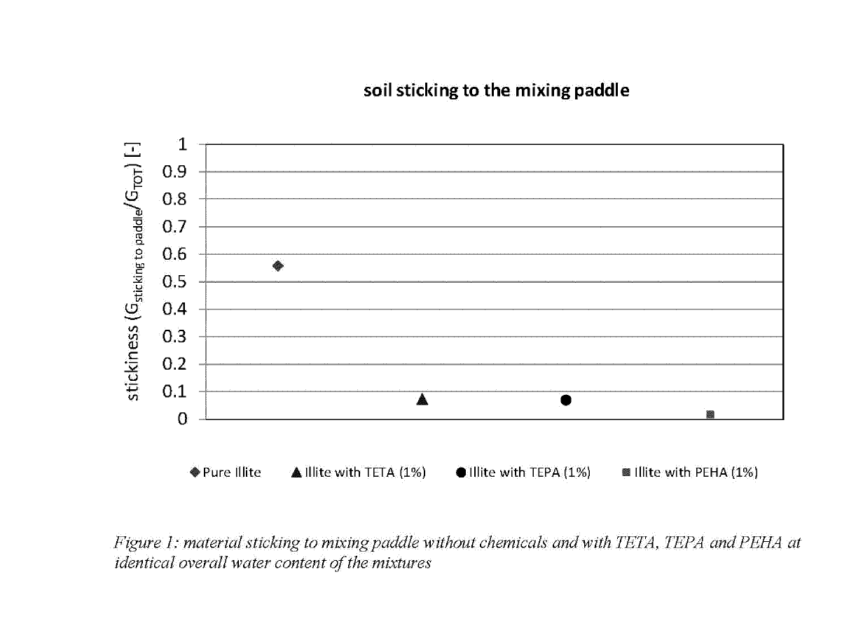

FIG. 1 shows the influence of addition of different polyamines (TETA, TEPA, PEHA at a concentration of 1% by weight to illite clay on the material sticking to mixing paddle compared with a mixture without any chemicals at the same water content (paste-like mixture). The ratio of the soil sticking to the mixing paddle of the Hobart kitchen mixer to the overall weight of soil in the mixer is plotted. As can be seen this ratio decreases dramatically when polyamine at a concentration of 1% by weight is added.

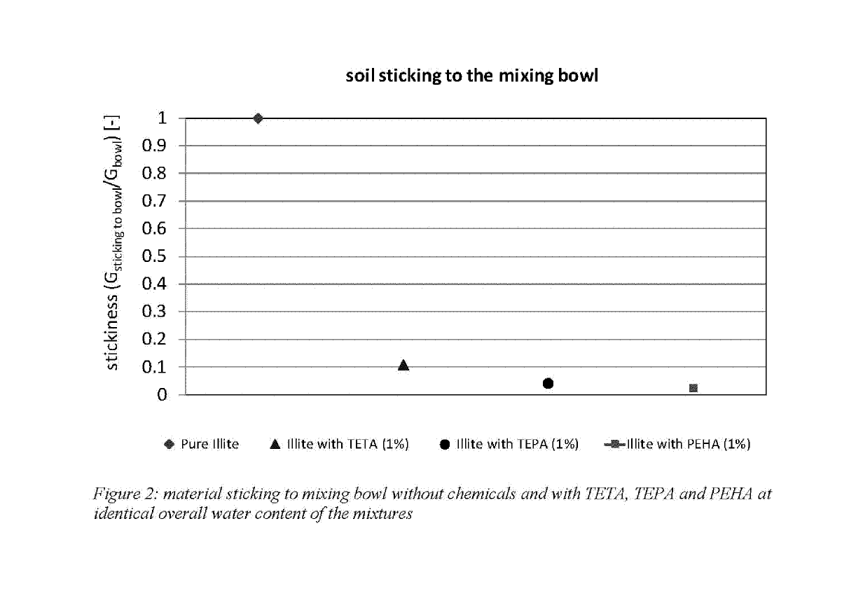

FIG. 2 shows the influence of addition of different polyamines (TETA, TEPA, PEHA) at a concentration of 1% by weight to illite clay on the material sticking to the mixing bowl compared with a mixture without any chemicals at the same content. The ratio of the soil sticking to the bowl after overturning related to the soil in the bowl after mixing is plotted. Also this ratio is decreasing drastically when adding the selected polyamines.

A strong effect of TETA, TEPA and PEHA on the mechanical behavior, in particular the sticking properties of clay containing soils or clay itself could already be observed when mixing it. The effect of PEHA was higher than the effect of TEPA, which has itself a higher efficiency than TETA. This means that a dependency on the molecular mass can be observed. Furthermore, it could be noticed, that the efficiency is dependent on the concentration of the polyamines.

1. Method of use of at least one polyamine compound selected from the group consisting of diethylenetriamine, triethylenetetramine (TETA), tetraethylenpentamine (TEPA), pentaethylenehexamine (PEHA), hexaethyleneheptamine and heptaethyleneoctamine as sticking decreasing additive for soil with a clay mineral content of more than 10% by weight.

2. The method according to claim 1, characterized in, that the polyamine is used at a concentration of from 0.5 to 2.0% by weight of the clay mineral content.

3. The method according to claim 1, characterized in, that the clay is represented by at least one species selected from the group consisting of illite, kaolinite and smectite.

4. The method according to claim 1, characterized in, that the polyamine is used in combination with polycarboxylates based dispersants.

5. The method according claim 4, characterized in, that the dispersants have anti-sticking properties over clay.

6. The method according to claim 4, characterized in, that the polyamine and/or the dispersant is/are used in liquid form.

7. (canceled)

8. The method according to claim 1, characterized in, that TEPA is used in the case that the clay is represented mainly by illite.

9. The method according to claim 1, characterized in, that PEHA is used in the case that the clay is represented mainly by kaolinite and/or smectite.

10. The method according to claim 1, characterized in, that the polyamine is used during tunnel excavation.

11. The method according to claim 4, characterized in, that the polyamine and the dispersant are used in liquid form as one combined liquid additive.

12. The method according to claim 11, characterized in, that the liquid additive is applied to the clay containing soil in amounts of from 0.5 to 2.0% by weight of the clay mineral content.

13. The method according to claim 11, characterized in, that the liquid additive is applied to the clay containing soil in an amount of 1.0% by weight of the clay mineral content.

14. The method according to claim 1, characterized in, that the polyamine is used at a concentration of 1.0% by weight of the clay mineral content.
